(19) United States
(12) Patent Application Publication
(10) Pub. No.: US 2015/0330641 A1
(43) Pub. Date: Nov. 19, 2015

(54) DOWNDRAFT VENTILATION SYSTEM

(71) Applicant: Broan-NuTone LLC, Hartford, WI (US)

(72) Inventor: Brent Lillesand, Hartford, WI (US)

(21) Appl. No.: 14/704,378

(22) Filed: May 5, 2015

Related U.S. Application Data
(60) Provisional application No. 61/993,775, filed on May 15, 2014.

(51) Int. Cl. F24C 15/20; B23P 19/00

(52) U.S. Cl. CPC F24C 15/2085; B23P 19/00

(57) ABSTRACT

A downdraft ventilation system can comprise: a movable chimney; an actuator configured to couple to and move the movable chimney; and a safety mechanism. The safety mechanism can include: a fixed bracket configured to engage the movable chimney member; a floating bracket configured to be positioned within and releasably engaged to the fixed bracket, the floating bracket configured to couple to the actuator; an energy storage member having a first end and a second end, the first end configured to engage the fixed bracket and the second end configured to engage the floating bracket; and at least one limit switch configured to engage the fixed bracket and the floating bracket, the at least one limit switch configured to remove power to the actuator when an obstruction of the movable chimney causes the floating bracket and the fixed bracket to disengage.

### CLAIM OF PRIORITY

This application claims the benefit of U.S. Provisional Patent Application Ser. No. 61/993,775, titled “DOWNDRAFT VENTILIATION SYSTEM” to Brent Lillesand, filed on May 15, 2014, which is incorporated by reference herein in its entirety.

### BACKGROUND

The desire for ventilation solutions that do not significantly interfere with kitchen sight-lines drives consumer purchasing of many conventional downdraft ventilation systems. Many consumers, for example, desire a smaller kitchen footprint with products that do not obstruct, block, or close-off spaces within the kitchen. A downdraft ventilation system can be positioned in a kitchen island or peninsula and can include a movable chimney. The movable chimney can raise and lower from a position under a kitchen counter, which can result in significant portions of the movable chimney being hidden when not in use.

### Overview

The present inventor recognizes the importance of the safe operation of a downdraft ventilation system that raises and lowers from a range, countertop or kitchen peninsula. A downdraft ventilation system can include a downdraft safety mechanism that can prevent a movable chimney from lowering further if the movable chimney has become obstructed by an object such as a hand or finger. The downdraft safety mechanism of this disclosure can include limit switches that operate quickly and with a small amount of movement. The downdraft ventilation system can include a linear actuator with a high degree of stability for fast operation that prevents premature deactivations of the movable chimney and can be configured for a flexible range of downward forces that produce a motor shut off.

To further illustrate the DOWNDRAFT VENTILATION SYSTEM disclosed herein, a non-limiting list of examples is provided here:

In Example 1, a downdraft ventilation system can comprise: a movable chimney; an actuator configured to couple to and move the movable chimney; a safety mechanism including: a fixed bracket configured to engage the movable chimney member; a floating bracket configured to be positioned within and releasably engaged to the fixed bracket, the floating bracket configured to couple to the actuator; an energy storage member having a first end and a second end, the first end configured to engage the fixed bracket and the second end configured to engage the floating bracket; and at least one limit switch configured to engage the fixed bracket and the floating bracket, the at least one limit switch configured to remove power to the actuator when an obstruction of the movable chimney causes the floating bracket and the fixed bracket to disengage.

In Example 2, the downdraft ventilation system of Example 1 can optionally be configured such that the fixed bracket is rectangularly shaped, the fixed bracket having a first side, a second side, a third side, a first flange extending from the second side toward the third side, and a second flange extending from the third side toward the second side, the first flange and the second flange defining an opening therebetween.

In Example 3, the downdraft ventilation system of Example 2 can optionally be configured such that at least one of the first flange and the second flange prevent movement of the floating bracket member.

In Example 4, the downdraft ventilation system of any one or any combination of Examples 2-3 can optionally be configured such that the actuator extends through the opening.

In Example 5, the downdraft ventilation system of any one or any combination of Examples 2-4 can optionally be configured to comprise a fastener configured to fasten the actuator to the floating bracket, wherein the first side defines an aperture configured to receive the fastener.

In Example 6, the downdraft ventilation system of any one or any combination of Examples 2-5 can optionally be configured to comprise at least one bracket fastener, the at least one bracket fastener extending through the first side, the energy storage member, the floating bracket and one of the first flange or the second flange.

In Example 7, the downdraft ventilation system of any one or any combination of Examples 1-6 can optionally be configured such that the actuator is selected from the group consisting of: a hydraulic linear actuator, an electric linear actuator, and a pneumatic linear actuator.

In Example 8, the downdraft ventilation system of any one or any combination of Examples 1-7 can optionally be configured such that the at least one limit switch includes two limit switches.

In Example 9, the downdraft ventilation system of any one or any combination of Examples 1-8 can optionally be configured such that the energy storage member is selected from the group consisting of: a spring, a rubber bumper, a pneumatic device, a metal, a rubber, and a composite of metal and rubber.

In Example 10, the downdraft ventilation system of any one or any combination of Examples 1-9 can optionally be configured to comprise a guide bracket configured to couple to the movable chimney, wherein the fixed bracket is configured to couple to the guide bracket.

In Example 11, the downdraft ventilation system of any one or any combination of Examples 1-10 can optionally be configured such that a weight of the movable chimney is configured to compress the energy storage member and engage the fixed bracket and the floating bracket.

In Example 12, the downdraft ventilation system of any one or any combination of Examples 1-11 can optionally be configured such that the energy storage member is configured to: provide a force between the fixed bracket and the floating bracket; and provide a counterforce to a portion of the weight of the movable chimney.

In Example 13, the downdraft ventilation system of any one or any combination of Examples 1-12 can optionally be configured such that the energy storage member is configured to allow disengagement between the floating bracket and the fixed bracket when the movable chimney provides a force on the obstruction of more than about 3 pounds.

In Example 14, the downdraft ventilation system of any one or any combination of Examples 1-13 can optionally be configured such that the energy storage member is configured to allow disengagement between the floating bracket and the fixed bracket when the movable chimney provides a force on the obstruction of more than about 15 pounds.

In Example 15, the downdraft ventilation system of any one or any combination of Examples 1-14 can optionally be configured such that the floating bracket member comprises: a first member opposing a rear member of the movable chimney; a top flange located in a plane transverse to the first member; and a lower flange located in a plane transverse to the first member.

In Example 16, a downdraft ventilation method can comprise providing a movable chimney comprising; an actuator configured to couple to and move the movable chimney; a safety mechanism including: a fixed bracket configured to engage the movable chimney member; a floating bracket configured to be positioned within and releasably engaged to the fixed bracket, the floating bracket configured to couple to the actuator; an energy storage member having a first end and a second end, the first end configured to engage the fixed bracket and the second end configured to engage the floating bracket; at least one limit switch configured to engage the fixed bracket and the floating bracket, the at least one limit switch configured to remove power to the actuator and stop movement of the actuator; separating the floating bracket and the fixed bracket if the movable chimney becomes obstructed by an obstruction during movement of the movable chimney; and stopping movement of the linear actuator with the safety switch upon separation of the fixed bracket and the floating bracket.

In Example 17, the downdraft ventilation method of Example 16 can optionally be configured such that separating the floating bracket and the fixed bracket if the movable chimney becomes obstructed by an obstruction during movement of the movable chimney includes: separating the floating bracket and the fixed bracket when the movable chimney provides a force on the obstruction of more than about 3 pounds.

In Example 18, a downdraft ventilation system can comprise: a movable chimney member, the movable chimney configured to move through a countertop opening; a linear actuator configured to couple to and move the movable chimney; a safety mechanism including: a fixed bracket configured to engage the movable chimney member, the fixed bracket is rectangularly shaped, the fixed bracket having a first side, a second side, a third side, a first flange extending from the second side toward the third side, and a second flange extending from the third side toward the second side, the first flange and the second flange defining an opening therebetween; a floating bracket configured to engage the fixed bracket, the floating bracket located within the fixed bracket, the floating bracket configured to couple to the actuator, the floating bracket including a first member opposing a rear member of the movable chimney, the floating bracket including a top flange located in a plane transverse to the first member, the floating bracket including a lower flange located in a plane transverse to the first member; a compression spring having a first end and a second end, the first end engaging the fixed bracket and the second end engaging the floating bracket; a guide bracket configured to couple to the movable chimney, wherein the fixed bracket is configured to couple to the guide bracket; and at least one limit switch configured to engage the fixed bracket and the floating bracket, the at least one limit switch configured to remove power from the linear actuator and stop movement of the movable chimney when an obstruction causes the floating bracket and the fixed bracket to disengage.

In Example 19, the downdraft ventilation system of Example 18 can optionally be configured such that the compression spring is configured to allow disengagement between the floating bracket and the fixed bracket when the movable chimney provides a force on the obstruction of more than about 15 pounds.

In Example 20, the downdraft ventilation system of any one or any combination of Examples 18-19 can optionally be configured such that the weight of the movable chimney compresses the compression spring.

In Example 21, the downdraft ventilation system or method of any one or any combination of Examples 1-20 can optionally be configured such that all elements, operations, or other options recited are available to use or select from.

These and other examples and features of the present downdraft ventilation system and methods will be set forth in part in the following Detailed Description. This Overview is intended to provide non-limiting examples of the present subject matter—it is not intended to provide an exclusive or exhaustive explanation. The Detailed Description below is included to provide further information about the present downdraft ventilation system (downdraft ventilation system) and methods.

### BRIEF DESCRIPTION OF THE DRAWINGS

Corresponding reference characters indicate corresponding parts throughout the several views. The exemplifications set out herein illustrate exemplary embodiments of the invention, and such exemplifications are not to be construed as limiting the scope of the invention in any manner.

FIG. 1 illustrates a perspective view of a portion of a downdraft ventilation system, in accordance with at least one example of the present disclosure.

FIG. 2 illustrates a perspective view of a portion of a downdraft ventilation system with the movable chimney in a lowered position, in accordance with at least one example of the present disclosure.

FIG. 3 illustrates a rear view of a portion of a downdraft ventilation system showing an actuator, in accordance with at least one example of the present disclosure.

FIG. 4 illustrates another rear view of a portion of a downdraft ventilation system showing an actuator with the movable chimney in a raised position, in accordance with at least one example of the present disclosure.

FIG. 5 illustrates a perspective view of a portion of a safety mechanism for a downdraft ventilation system, in accordance with at least one example of the present disclosure.

FIG. 6 illustrates an exploded view of a portion of a safety mechanism for a downdraft ventilation system, in accordance with at least one example of the present disclosure.

FIG. 7 illustrates an exploded view of a portion of a safety mechanism for a downdraft ventilation system, in accordance with at least one example of the present disclosure.

FIG. 8 illustrates a view of a safety mechanism before an obstruction of the movable chimney, in accordance with at least one example of the present disclosure.

FIG. 9 illustrates a view of a safety mechanism after an obstruction of the movable chimney, in accordance with at least one example of the present disclosure.

FIG. 10 illustrates a downdraft ventilation safety method, in accordance with at least one example of the present disclosure.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

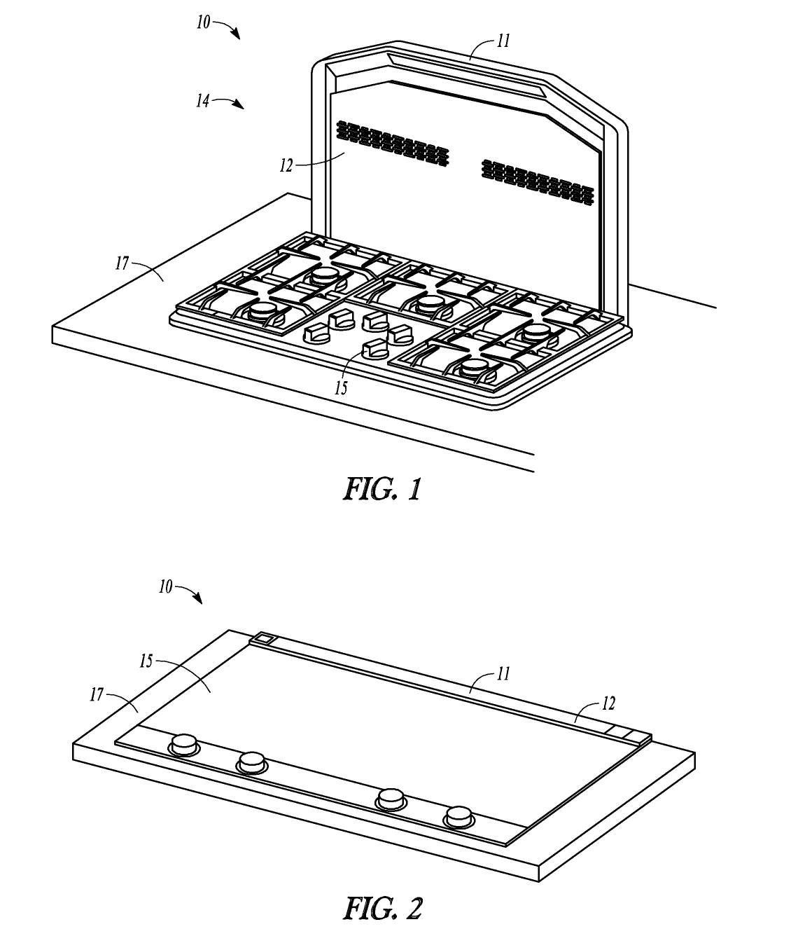

FIG. 1 illustrates a portion of downdraft ventilation system 10 according to one example configuration. The downdraft ventilation system 10 can include a movable chimney 12 comprising a substantially horizontal top member 11. As shown in FIG. 1, in some examples, the downdraft ventilation system 10 can be installed adjacent to a cooking area 14 (e.g., in a kitchen) and positioned adjacent to and/or coupled with a cooktop 15. Furthermore, in some examples, as discussed in greater detail below, at least some portions of the downdraft ventilation system 10 (e.g., a fluid box, a movement assembly, and/or the fluid outlets, etc.) can be installed substantially or completely under a counter surface 17, and coupled to a fluid box housing. A fluid box can comprise one or more ventilation assemblies for example, fans or other devices configured to move fluids, such as air.

In other example configurations, the downdraft ventilation system 10 can be installed and/or used in other portions of a home or other structure. For example, the downdraft ventilation system 10 can be used in a workshop or any other area that could require ventilation (e.g., a laundry, a basement, a bath-room, etc.). Accordingly, although the downdraft ventilation system 10 is described below as being installed in a kitchen area (e.g., adjacent to a cooktop 15), this description is not intended to limit the scope of this disclosure to kitchen or cooking-related applications. In some example implementations, when the downdraft ventilation system 10 is in an inactive state, e.g., the ventilation system is not in use, the movable chimney 12 can be in a substantially or completely lowered position.

FIG. 2 illustrates a perspective view of a portion of a downdraft ventilation system with the movable chimney in a lowered position, in accordance with at least one example of the present disclosure. For example the movable chimney 12 can be lowered so that the top member 11 of the movable chimney 12 is substantially flush with or lower than the counter surface 17 or the surface of the cooktop 15. As a result, when in an inactive state, most or substantially all the movable chimney 12 can be located under the counter surface 17 and not visible or less visible to a user (e.g., to provide an unobstructed view or pleasant aesthetic experience). Although the movable chimney 12 is illustrated as moving in upward and downward direction, the present inventor has contemplated other orientations, such as side to side movement, without changing the scope of this disclosure.

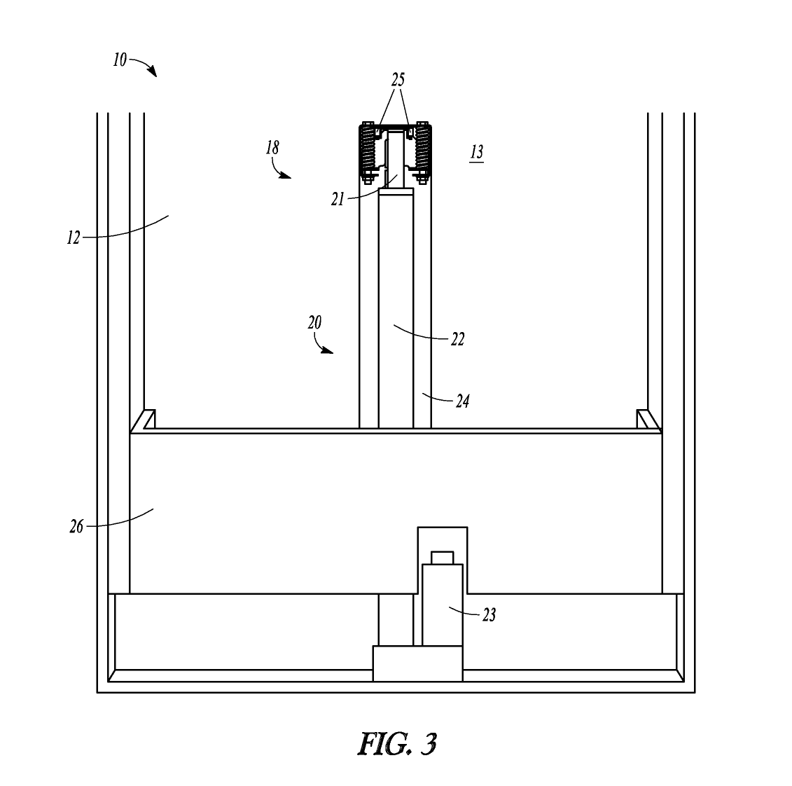

FIG. 3 illustrates a rear view of a downdraft ventilation system 10. In the example shown in FIG. 3, the downdraft ventilation system 10 can include a movement assembly 18 that can be configured and arranged to move the movable chimney 12. For example, the movement assembly 18 can be activated (e.g., automatically or manually) to move the movable chimney 12. The movable chimney 12 can include a rear member 13. The rear member 13 can be a planar panel. The rear member 13 can form a portion of the movable chimney 12 structure.

In some examples, the movement assembly 18 can be configured and arranged to raise and/or lower the movable chimney 12 (e.g., function as a telescoping mechanism). As shown in FIG. 3, when activated, during operation of the downdraft ventilation system 10, the movement assembly 18 can raise the movable chimney 12 so that the movable chimney 12 can exhaust at least a portion of cooking effluent created by a cooking episode. At or near an end of the cooking episode, the movement assembly 18 can be activated to lower the movable chimney 12 so that a top member 11 of the movable chimney 12 is at or below the surface of the counter surface 17 (e.g., substantially flush with, or below the counter surface level, see FIG. 2). In other examples, the movement assembly 18 can be configured and arranged to move the chimney in other directions (e.g., side-to-side, diagonally, etc.) The movement assembly 18 can include a plurality of different configurations, for example, as a linear actuator, as a scissors lift, as a geared rack and pinion, or configured with a series of pulleys, cables, or wires.

As shown in FIG. 3, in some examples, the movement assembly 18 can include an actuator assembly 20. The actuator assembly 20 can engage the movable chimney 12 and be configured to raise or lower the movable chimney 12. The actuator assembly 20 can include an actuator 21, an actuator housing 22, an actuator motor 23, a guide bracket 24, and one or more limit switches 25. The actuator 21 can configured as a linear member or rod-like.

In the present application, the limit switches will be referred to collectively as limit switches 25 and if the discussion warrants individual recognition, the limit switches 25 will be referred to as 25a, 25b, etc. The actuator motor 23 can be an electric motor, a hydraulic motor, or a pneumatic motor. The actuator 21 can be powered by electricity, hydraulic oil, or air and each of these systems can include electrical circuitry including wiring and a power source. The downdraft ventilation system 10 can include a lower box portion 26 that engages the movable chimney 12 and can be sealed against air leakage. The lower box portion 26 can be connected to additional ventilation chambers or pathways. The lower box portion 26 can be in fluid communication with the movable chimney 12.

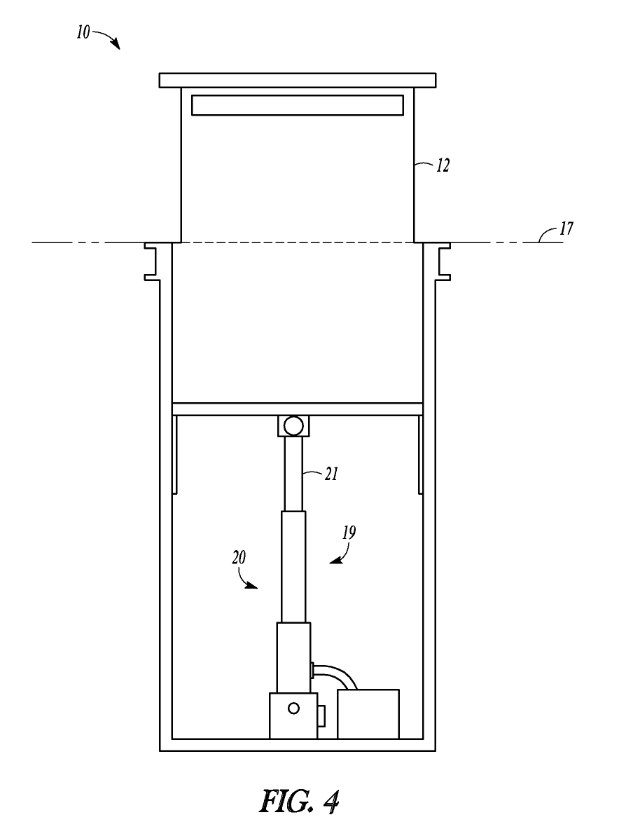

FIG. 4 illustrates another rear view of a downdraft ventilation system 10. The actuator assembly 20 can include an actuator 21 in an extended position and the movable chimney 12 in a raised position. FIG. 4 illustrates an alternate movement assembly 19 that can telescope to raise the movable chimney 12. The alternate movement assembly 19 can be hydraulic, electric, or pneumatic. The alternate movement assembly 19 can include one or more actuator assemblies 20. The alternate movement assembly 19 can be configured, for example, as a scissors lift, as a geared rack and pinion, or with a series of pulleys, cables, or wires.

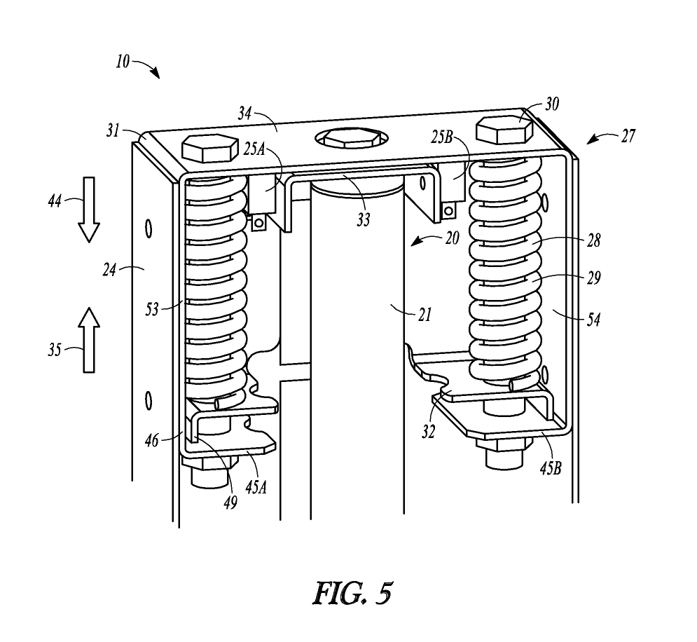

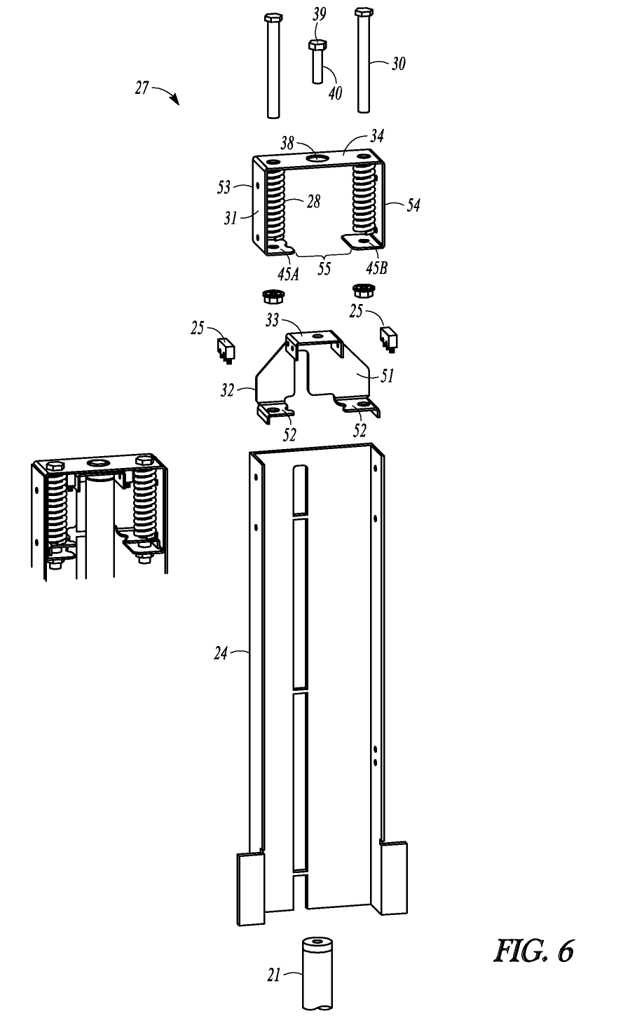

FIGS. 5 and 6 illustrate an example of a safety mechanism 27 of the downdraft ventilation system 10. The safety mechanism 27 can include a guide bracket 24, a fixed bracket 31, a floating bracket 32, one or more limit switches 25, one or more energy storage members 28, one or more bracket fasteners 30 and an actuator 21. The safety mechanism 27 can incorporate both mechanical and electrical components. The guide bracket 24 can be attached to the rear of a movable chimney 12, such as to the rear member 13 and can engage mating features on a lower box portion 26 (see FIG. 3). The fixed bracket 31 can be attached to the guide bracket 24 or to the movable chimney 12. The fixed bracket 31 can be rectangularly shaped having a first side 34, a second side 53, and a third side 54. The fixed bracket 31 can include a first flange 45a extending from the second side 53 towards the third side 54. The fixed bracket 31 can include a second flange 45b extending from the third side 54 towards the second side 53. The first and second flanges 45a, 45b can add strength to the fixed bracket 31 and also provide an attachment point for a fastener. An opening 55 can be defined between the first flange 45a and the second flange 45b. The actuator 21 can extend through the opening 55.

The floating bracket 32 can be attached to the actuator 21 and can slide up or down within the fixed bracket 31. The floating bracket 32 can be inside of the fixed bracket 31. When a command from a controller or switch (not depicted) to raise the movable chimney 12 is received (see FIG. 1), the actuator 21 can move upwardly and a portion of the floating bracket 32 such as a top flange 33 of the floating bracket 32 can contact the fixed bracket 31 such as at a first side 34. The floating bracket 32 can push against the fixed bracket 31 at the first side 34 and the movable chimney 12 can raise upwardly 35.

One or more limit switches 25 can be attached to either the floating bracket 32 or the fixed bracket 31. The limit switches 25 can be configured as switches that are normally closed and, when actuated, open to shut off power. In another example configuration, the limit switches 25 can be configured as switches that are normally open and, when actuated, close to shut off power. Two limit switches 25a and 25b can be used for redundancy in the event that one limit switch 25 fails or if a limit switch 25a on one side opens the circuit before a second limit switch 25b on the other side opens, for example if the movable chimney becomes slanted, unbalanced, or off track. The energy storage members 28 can be springs, rubber bumpers, compressed air devices or other such energy storage devices as is known in the art. The energy storage members 28 can be formed of metal, rubber, plastics, polymers, or a composite having combinations of two or more of the aforementioned materials. In the example shown in FIG. 5, the energy storage members 28 are illustrated as a compression spring 29. The energy storage member 28 can be disposed over a bracket fastener 30 and can be located between the fixed bracket 31 and the floating bracket 32. The bracket fastener 30 can extend through the fixed bracket 31, extend through the energy storage member 28, extend through the floating bracket 32 and can include a fastener nut.

The safety mechanism 27 can be designed to allow the fixed bracket 31 (attached to the movable chimney 12) to separate from the floating bracket 32 (attached to the actuator assembly 20) when an obstruction to movement of the movable chimney 12 occurs. The energy storage member 28 can absorb and offset the force exerted by the weight of the movable chimney 12. The energy storage member can provide a counterforce to the force exerted by the weight of the movable chimney 12. The weight of the movable chimney 12 can compress the energy storage member 28 and allow the fixed bracket 31 to engage the floating bracket 32. If the movable chimney 12, encounters an obstruction during downward movement 44, the energy storage member 28 can provide a counterforce to the force exerted by the weight of the movable chimney 12. This counterforce can aid separation between the fixed bracket 31 and the floating bracket 32, without requiring that the full weight of the movable chimney 12 be lifted off the floating bracket 32 and the actuator 21.

The energy storage member 28 can be configured or calibrated, e.g., using a spring constant, so that a designated amount of force can cause a separation 43 (see FIG. 9) between the fixed bracket 31 and the floating bracket 32 and the actuation of the limit switches 25. For example, the downdraft ventilation system 10 can be configured so that the movable chimney 12 exerts less than about 15 pounds of force on an obstruction or an object causing an obstruction, e.g., a user's hand or finger, before the floating bracket 32 and the fixed bracket 31 disengage and the actuator motor 23 (see FIG. 3) can be shut off. The downdraft ventilation system 10 can be configured for other shut-off force values by providing different sizes or positioning of energy storage members 28. In an example, an energy storage member 28 that is longer and/or stronger can cause separation with less than about 7 pounds of force exerted on an obstruction. In an example, energy storage member 28 can cause separation with less than about 3 pounds of force exerted on an obstruction.

In one example configuration, the weight of the movable chimney 12 can compress the limit switch(s) 25. This can allow faster actuator assembly 20 speeds or lift rate and greater movable chimney 12 stability. Such stability can prevent premature deactivation of the actuator motor 23 (see FIG. 3), which can occur in downdraft ventilation systems without such stability if the lift rate is too fast. Such stability can also prevent the downdraft ventilation system from bouncing up and down like the suspension in an automobile.

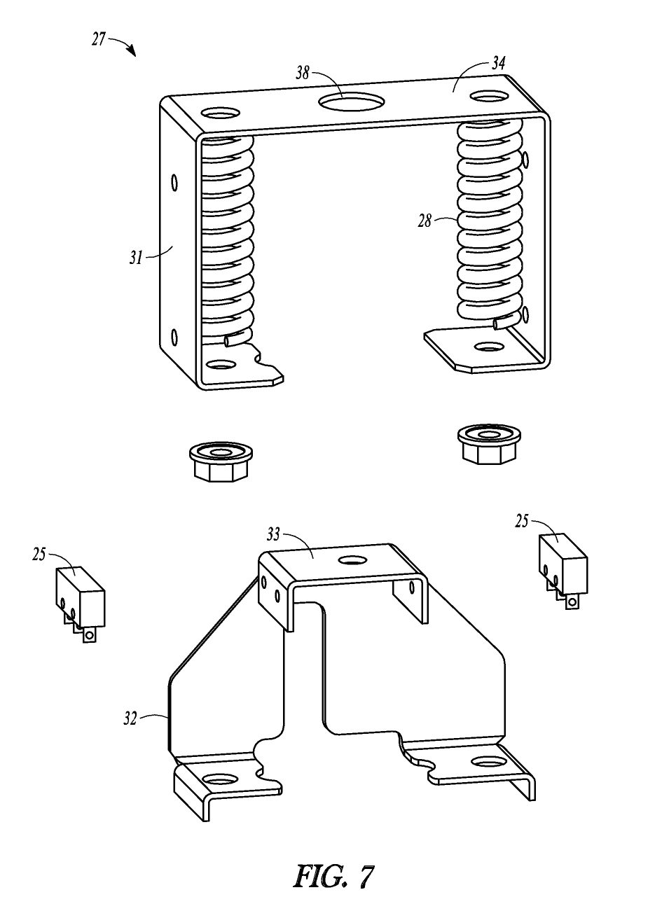

FIGS. 6 and 7 illustrate exploded views of the safety mechanism 27 and its components: the actuator 21, the guide bracket 24, the floating bracket 32, the limit switches 25, the fixed bracket 31, the energy storage member 28 and the bracket fasteners 30. The guide bracket 24 can include a channel shape or U-shape. The guide bracket 24 can be a strengthening member for the movable chimney 12 (see FIG. 3) as well as mate to similar structures in other portions of the ventilation system as previously described. Note that the aperture 38 in the first side 34 can be larger than the head 39 of a fastener 40. The fastener 40 can attach the floating bracket 32 to the top of the actuator 21. The aperture 38 can allow the first side 34 to engage the top flange 33 of the floating bracket 32 (see also FIG. 5). The floating bracket 32 can include a first member 51, a top flange 33, and a lower flange 52. The first member 51 can oppose the rear member 13, or a similar surface of the guide bracket 24. The top flange 33 and the lower flange 52 can be transverse to the first member 51.

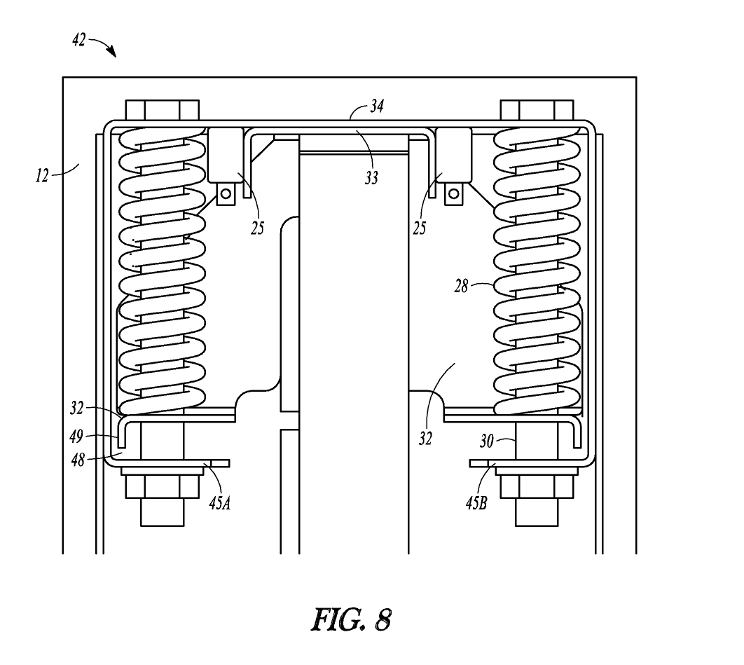

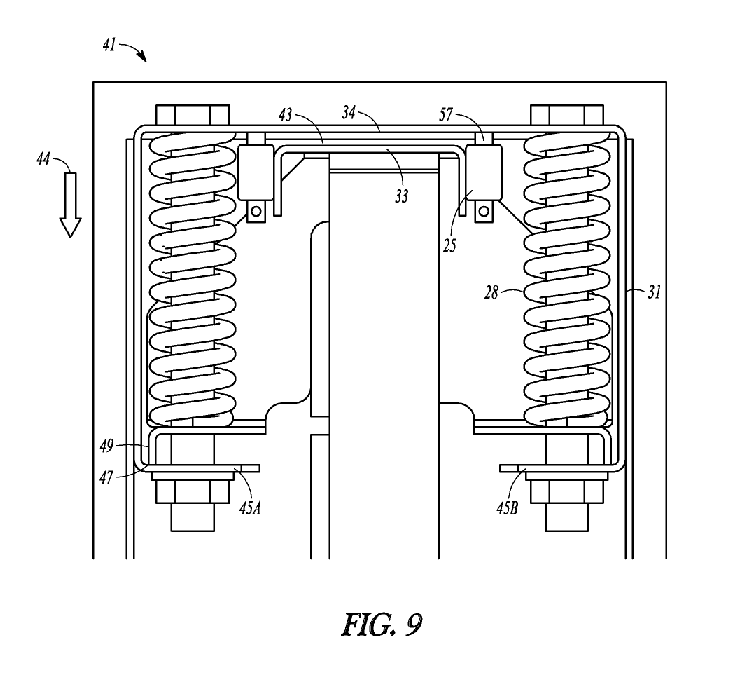

FIGS. 8 and 9 illustrate the open position 41 and closed positions 42 of the limit switches 25 and movement between the fixed bracket 31 and the floating bracket 32 that can cause a separation 43 between the bottom of the first side 34 and the upper surface of the top flange 33. The separation 43 can allow the limit switches 25 to open/close (depending on electrical circuitry) to shut off the actuator assembly 20 from further downward 44 movement. The limit switches 25 can include a spring or energy storage member that can allow an actuator to extend if the actuator is not blocked by a structure such as the first side 34.

When the movable chimney 12 is lowered, an obstruction can cause the movable chimney 12 to stop movement. Because the actuator 21 is not directly attached to the movable chimney 12, the actuator 21 can continue to lower. The floating bracket 32 can be attached to the actuator 21 and also can continue to lower. As the floating bracket 32 separates from the fixed bracket 31, the limit switches 25 can actuate. A limit switch actuator 57 can extend, because it is no longer obstructed by the bottom of the first side 34. In an example, the limit switch(es) 25 can actuate within about 0.030″ to about 0.090″ of travel, which can cause the actuator motor 23 to shut off quickly (see FIG. 3). Once the obstruction is removed, the movable chimney 12 and the fixed bracket 31 can be located back down onto the floating bracket 32 and the limit switches 25 can return to their operating position. The movable chimney 12 can resume travel.

The fixed bracket 31 can include first and second flanges 45a, 45b disposed on a lower end 46 of the fixed bracket 31 (see also FIG. 5). The bottom first and second flanges 45a, 45b can provide a stop 47 for a lower contact member 49 of the floating bracket, and prevent further downward movement of the floating bracket 32 and also provide an attachment point for the bracket fasteners 30. When the floating bracket 32 is not bottomed out against the first or second flanges 45a, 45b, the weight of the movable chimney 12 can be supported by the energy storage member 28. When there is no obstruction and the movable chimney 12 is in an operating mode (e.g., not shut off by the limit switches 25) there can be a floating space 48 between the first or second flanges 45a, 45b and the lower contact member 49.

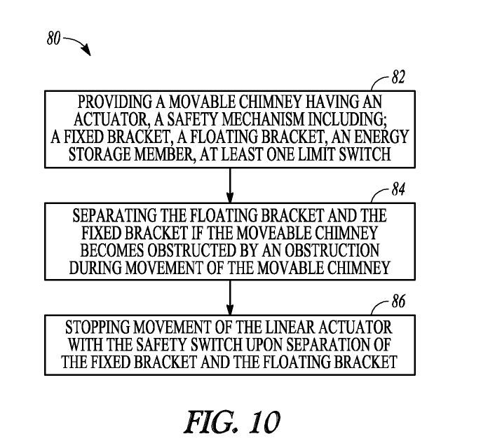

FIG. 10 illustrates a downdraft ventilation safety method 80, in accordance with at least one example of the present disclosure. Included in the method are providing a movable chimney 82, separating the fixed bracket and the floating bracket 84, and stopping movement of the actuator 86. Providing a movable chimney 82 can include a movable chimney that can comprise an actuator configured to couple to and move the movable chimney and a safety mechanism. The safety mechanism can include a fixed bracket configured to engage the movable chimney member; a floating bracket configured to be positioned within and releasably engaged to the fixed bracket, the floating bracket configured to couple to the actuator; an energy storage member having a first end and a second end, the first end configured to engage the fixed bracket and the second end configured to engage the floating bracket; and at least one limit switch configured to engage the fixed bracket and the floating bracket, the at least one limit switch configured to remove power to the actuator and stop movement of the actuator.

Separating the fixed bracket and the floating bracket 84 can occur if the movable chimney becomes obstructed by an obstruction during movement of the movable chimney. The energy storage member can be configured for different sizes and weights of movable chimneys and can be calibrated to allow separation of the fixed bracket from the floating bracket for whatever force on the obstruction is desired. For example, the force which can cause separation should not be so light to cause undesired separations, but the force needs to be light enough not to cause any injury if the obstruction is a hand or a finger.

Stopping movement of the actuator 86 can be accomplished by one or more limit switches that engage the fixed bracket and the floating bracket. The limit switches can be in an electrical circuit connected to a power source for the actuator. The power source can be electrical. The actuator can be electric, hydraulic or pneumatic. When the limit switches are activated by the separation of the fixed bracket and the floating bracket, the power to the actuator can be removed and the actuator will stop movement. Any of the devices disclosed above can be utilized for the method described in FIG. 10.

### Additional Notes and Examples

The above Detailed Description includes references to the accompanying drawings, which form a part of the Detailed Description. The drawings show, by way of illustration, specific embodiments in which the present instrument use counters and methods can be practiced. These embodiments are also referred to herein as “examples.”

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In this document, the terms “a” or “an” are used to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “about” and “approximately” are used to refer to an amount that is nearly, almost, or in the vicinity of being equal to a stated amount.

What is claimed is:

1. A downdraft ventilation system comprising:
a movable chimney;
an actuator configured to couple to and move the movable chimney;
a safety mechanism including:
a fixed bracket configured to engage the movable chimney member;
a floating bracket configured to be positioned within and releasably engaged to the fixed bracket, the floating bracket configured to couple to the actuator;
an energy storage member having a first end and a second end, the first end configured to engage the fixed bracket and the second end configured to engage the floating bracket; and
at least one limit switch configured to engage the fixed bracket and the floating bracket, the at least one limit switch configured to remove power to the actuator when an obstruction of the movable chimney causes the floating bracket and the fixed bracket to disengage.

2. The downdraft ventilation system of claim 1, wherein the fixed bracket is rectangularly shaped, the fixed bracket having a first side, a second side, a third side, a first flange extending from the second side toward the third side, and a second flange extending from the third side toward the second side, the first flange and the second flange defining an opening therebetween.

3. The downdraft ventilation system of claim 2, wherein at least one of the first flange and the second flange prevent movement of the floating bracket member.

4. The downdraft ventilation system of claim 2, wherein the actuator extends through the opening.

5. The downdraft ventilation system of claim 2, comprising a fastener configured to fasten the actuator to the floating bracket, wherein the first side defines an aperture configured to receive the fastener.

6. The downdraft ventilation system of claim 2, comprising at least one bracket fastener, the at least one bracket fastener extending through the first side, the energy storage member, the floating bracket and one of the first flange or the second flange.

7. The downdraft ventilation system of claim 1, wherein the actuator is selected from the group consisting of: a hydraulic linear actuator, an electric linear actuator, and a pneumatic linear actuator.

8. The downdraft ventilation system of claim 1, wherein the at least one limit switch includes two limit switches.

9. The downdraft ventilation system of claim 1, wherein the energy storage member is selected from the group consisting of: a spring, a rubber bumper, a pneumatic device,
a metal, a rubber, and a composite of metal and rubber.

10. The downdraft ventilation system of claim 1, comprising a guide bracket configured to couple to the movable chimney, wherein the fixed bracket is configured to couple to the guide bracket.

11. The downdraft ventilation system of claim 1, wherein a weight of the movable chimney is configured to compress the energy storage member and engage the fixed bracket and the floating bracket.

12. The downdraft ventilation system of claim 1, wherein the energy storage member is configured to:
provide a force between the fixed bracket and the floating bracket; and
provide a counterforce to a portion of the weight of the movable chimney.

13. The downdraft ventilation system of claim 1, wherein the energy storage member is configured to allow disengagement between the floating bracket and the fixed bracket when the movable chimney provides a force on the obstruction of more than about 3 pounds.

14. The downdraft ventilation system of claim 1, wherein the energy storage member is configured to allow disengagement between the floating bracket and the fixed bracket when the movable chimney provides a force on the obstruction of more than about 15 pounds.

15. The downdraft ventilation system of claim 1, wherein the floating bracket member comprises:
a first member opposing a rear member of the movable chimney;
a top flange located in a plane transverse to the first member; and
a lower flange located in a plane transverse to the first member.

16. A downdraft ventilation safety method comprising:
providing a movable chimney comprising;
an actuator configured to couple to and move the movable chimney;
a safety mechanism including:
a fixed bracket configured to engage the movable chimney member;
a floating bracket configured to be positioned within and releasably engaged to the fixed bracket, the floating bracket configured to couple to the actuator;
an energy storage member having a first end and a second end, the first end configured to engage the fixed bracket and the second end configured to engage the floating bracket;
at least one limit switch configured to engage the fixed bracket and the floating bracket, the at least one limit switch configured to remove power to the actuator and stop movement of the actuator;
separating the floating bracket and the fixed bracket if the movable chimney becomes obstructed by an obstruction during movement of the movable chimney; and
stopping movement of the linear actuator with the safety switch upon separation of the fixed bracket and the floating bracket.

17. The method of claim 16, wherein separating the floating bracket and the fixed bracket if the movable chimney becomes obstructed by an obstruction during movement of the movable chimney includes:
separating the floating bracket and the fixed bracket when the movable chimney provides a force on the obstruction of more than about 3 pounds.

18. A downdraft ventilation system comprising:
a movable chimney member, the movable chimney configured to move through a countertop opening;
a linear actuator configured to couple to and move the movable chimney;
a safety mechanism including:
a fixed bracket configured to engage the movable chimney member, the fixed bracket is rectangularly shaped, the fixed bracket having a first side, a second side, a third side, a first flange extending from the second side toward the third side, and a second flange extending from the third side toward the second side, the first flange and the second flange defining an opening therebetween;
a floating bracket configured to engage the fixed bracket, the floating bracket located within the fixed bracket, the floating bracket configured to couple to the actuator, the floating bracket including a first member opposing a rear member of the movable chimney, the floating bracket including a top flange located in a plane transverse to the first member, the floating bracket including a lower flange located in a plane transverse to the first member;
a compression spring having a first end and a second end, the first end engaging the fixed bracket and the second end engaging the floating bracket;
a guide bracket configured to couple to the movable chimney,
wherein the fixed bracket is configured to couple to the guide bracket; and
at least one limit switch configured to engage the fixed bracket and the floating bracket, the at least one limit switch configured to remove power from the linear actuator and stop movement of the movable chimney when an obstruction causes the floating bracket and the fixed bracket to disengage.

19. The downdraft ventilation system of claim 18, wherein the compression spring is configured to allow disengagement between the floating bracket and the fixed bracket when the movable chimney provides a force on the obstruction of more than about 15 pounds.

20. The downdraft ventilation system of claim 18, wherein the weight of the movable chimney compresses the compression spring.
